(19) United States
(12) Patent Application Publication
(10) Pub. No.: US 2001/0007215 A1
(43) Pub. Date: Jul. 12, 2001

(54) Cutting tool and cutting process

(75) Inventors: Shintaro Murata, Nagoya-shi (JP); Katsuzi Yonekawa, Chiryu-shi (JP)

Correspondence Address: Oliff & Berridge PLC, P.O. Box 19928, Alexandria, VA, 22320, US

(73) Assignee: FUJI MACHINE MFG. CO., LTD.

(21) Appl. No.: 09/745,528

(22) Filed: Dec. 26, 2000

(30) Foreign Application Priority Data
Jan. 11, 2000 (JP) 2000-002434

(51) Int. Cl. B26D 7/08

(52) U.S. Cl. 83/16; 83/171

(57) ABSTRACT

A cutting tool, including a main portion having a tip-hold surface, and a tip which has a cutting edge and which is detachably attached to the main portion such that the tip is held in close contact with the tip-hold surface of the main portion, the tip having a tip-side mist hole which is formed through the tip and which has an inlet in a surface of the tip that is held in close contact with the tip-hold surface of the main portion, and an outlet in a portion of the tip that is located in a vicinity of the cutting edge, the main portion having a main-portion-side mist hole which is formed through the main portion and which opens, in the tip-hold surface, at a position aligned with the inlet of the tip-side mist hole of the tip attached to the main portion.

### BACKGROUND OF THE INVENTION

1. Field of the Invention

The present invention relates to a process of cutting a workpiece using a superfine mist of a cutting liquid, and a cutting tool and a tip which are suitable for carrying out the cutting process.

2. Discussion of Related Art

There is known a process of cutting, using a cutting tool, a workpiece while supplying a superfine mist of a cutting liquid, such as a cutting oil or a suspension, to a cutting point between the tool and the workpiece. If the cutting liquid is used in the form of superfine mist, then the amount of consumption of cutting liquid can be largely reduced as compared with the case where the cutting liquid is used as it is, i.e., in the form of liquid. Thus, this process is often called as semi-dry cutting process. If the cutting liquid is used as it is, then a large amount of cutting liquid is needed, which leads to increasing the running cost, worsening the environment of both the cutting tool and an operator because the liquid is scattered as the tool and/or the workpiece is rotated, and making it difficult to treat the chips produced by the cutting process because the liquid is adhered to the chips. The semi-dry cutting process is free of those problems.

Meanwhile, there is known a drill or an end mill whose body has a mist hole which is formed therethrough and via which a superfine mist of a cutting liquid is supplied to a cutting point. However, in a cutting tool, such as a single-point tool, a boring tool, or a milling cutter, that includes a main portion and a tip which has a cutting edge and is detachably attached to the main portion, a superfine mist is just sprayed toward a cutting point. Since the superfine mist is externally sprayed toward the cutting point, it is difficult for the superfine mist to reach the cutting point. Since in the cutting process the cutting tool and/or the workpiece is rotated, air flow is generated around a member or members which is or are rotated, and the air flow generated prevents the superfine mist from reaching the cutting point. If the pressure to spray the superfine mist or the amount of spraying of the mist is increased, then it is possible for the mist to reach the cutting point. In the last case, however, the amount of consumption of cutting liquid is increased, and the above-indicated advantages of the semi-dry cutting process are lost.

### SUMMARY OF THE INVENTION

The present invention provides a cutting tool, a tip, and a cutting process which have one or more of the following technical features that are described below in respective paragraphs given parenthesized sequential numbers (1) to (8). Any technical feature that includes another technical feature shall do so by referring, at the beginning, to the parenthesized sequential number given to the latter feature. However, the following technical features and the appropriate combinations thereof are just examples to which the present invention is by no means limited. In addition, in the case where one technical feature recites a plurality of items, it is not essentially required that all of those items be simultaneously employed. That is, it is possible to select and employ only a portion (one, two, . . . , but not all) of those items.

(1) According to a first feature of the present invention, there is provided a cutting tool, comprising a main portion having a tip-hold surface; a tip which has a cutting edge and which is detachably attached to the main portion such that the tip is held in close contact with the tip-hold surface of the main portion; the tip having a tip-side mist hole which is formed through the tip and which has an inlet in a surface of the tip that is held in close contact with the tip-hold surface of the main portion, and an outlet in a portion of the tip that is located in a vicinity of the cutting edge; and the main portion having a main-portion-side mist hole which is formed through the main portion and which opens, in the tip-hold surface, at a position aligned with the inlet of the tip-side mist hole of the tip attached to the main portion. The cutting tool may be a single-point tool, a boring tool, or a milling cutter.

In the present cutting tool, a mist hole is formed in each of the main portion and the tip and, in the state in which the tip is attached to the main portion, the tip-side mist hole and the main-portion-side mist hole are communicated with each other. Therefore, when the superfine mist is blown into the main-portion-side mist hole, the superfine mist is effectively supplied to the cutting point from the outlet of the chip-side mist hole. Thus, the present cutting tool can carry out an excellent semi-dry cutting process.

(2) According to a second feature of the present invention that includes the first feature (1), the main portion comprises an elongate shank including an end portion having the tip-hold surface, and the tip is detachably attached to the tip-hold surface of the shank.

A cutting tool including an elongate shank and a tip detachably attached to the shank is called as a single-point tool, and is widely employed in a lathe. In addition, in a large-diameter boring tool or milling cutter, the single-point tool is detachably attached to a large-size main portion. The single-point tool can effectively supply the superfine mist to the cutting point in the semi-dry cutting process.

(3) According to a third feature of the present invention that includes the second feature (2), the tip has a rake face, a major flank, and a minor flank, and the outlet of the tip-side mist hole opens in at least one of the rake face, the major flank, and the minor flank.

In the tip, the cutting edge is defined as intersection lines of the rake face, the major flank, and the minor flank. Since the outlet of the tip-side mist hole opens in at least one of those faces, the present cutting tool can effectively supply the superfine mist to the cutting point where the tip cuts the workpiece.

(4) According to a third feature of the present invention that includes any one of the first to third features (1) to (3), the main portion has a substantially circular transverse cross section, and the cutting tool comprises a plurality of the tips which are attached to an outer circumferential surface of the main portion such that the tips are spaced from each other in a circumferential direction of the main portion.

(5) According to a fifth feature of the present invention that includes the fourth feature (4), the tips are attached to the outer circumferential surface of the main portion such that the tips are equiangularly spaced from each other about a centerline of the main portion in the circumferential direction thereof.

The present cutting tool may be used as a cutting tool of a milling machine or a gear cutting machine, i.e., a milling cutter or a gear cutter.

(6) According to a sixth feature of the present invention, there is provided a tip for cooperating with a main portion of a cutting tool to provide the cutting tool, the tip being detachably attached to the main portion such that the tip is held in close contact with a tip-hold surface of the main portion, the improvement comprising at least one mist hole which is formed through the tip and which has two opposite ends one of which opens in a surface of the tip that is held in close contact with the tip-hold surface of the main portion, and the other of which opens in a portion of the tip that is located in a vicinity of a cutting edge of the tip.

(7) According to a seventh feature of the present invention, there is provided a process of cutting a workpiece, comprising the step of cutting, with the cutting tool according to any one of the first to fifth features (1) to (5), the workpiece while supplying, to a cutting point between the tip and the workpiece, a superfine mist of a cutting liquid from the outlet of the tip-side mist hole via the main-portion-side mist hole and the tip-side mist hole.

The superfine mist of the cutting liquid may be a mixture of (a) a superfine particles of a cutting liquid, such as a cutting oil or a suspension, that have an average diameter of from 1 to 2.5 μm, and (b) a gas. The gas may be air or an inert gas. The inert gas may be nitrogen, carbonic acid gas, or a rare gas such as argon. If the air is used as the gas, the objects may be achieved at a low cost; and if the inert gas is used as the gas, the surfaces of the workpiece and the cutting tool that are easily heated by the heat generated by the cutting process are effectively prevented from oxidation.

(8) According to an eighth feature of the present invention that includes the seventh feature (7), the cutting tool comprises a single-point tool including the tip and a shank to which the tip is attached, and the process further comprises the step of sucking, by vacuum, chips produced by cutting the workpiece, together with an air around the cutting edge of the tip, and thereby removing the chips from the single-point tool.

In this process, the cutting process can be carried out with a small amount of cutting liquid, and the chips to which substantially no cutting liquid is adhered can be easily removed from the cutting space. Thus, the high-temperature chips are effectively prevented from accumulating on a frame member, such as a bed, of a cutting-tool system or thermally deforming the same, or from being adhered to a frictional surface of the system or damaging the same.

### BRIEF DESCRIPTION OF THE DRAWINGS

The above and other objects, features, advantages and technical and industrial significance of the present invention will be better understood by reading the following detailed description of preferred embodiments of the invention, when considered in connection with the accompanying drawings, in which:

FIG. 1 is a schematic, front elevation view of a lathe including a single-point tool as a sort of cutting tool to which the present invention is applied;

FIG. 2 is a partly cross-sectioned, front elevation view of the single-point tool;

FIG. 3 is a bottom view of the single-point tool;

FIG. 4 is a front elevation view of the single-point tool;

FIG. 5 is another bottom view of the single-point tool;

FIG. 6 is another front elevation view of the single-point tool;

FIG. 7 is a cross-sectioned view of the single-point tool, taken along A-A in FIG. 6;

FIG. 8 is a front elevation view of another single-point tool as a second embodiment of the present invention;

FIG. 9 is a cross-sectioned view of the single-point tool, taken along B-B in FIG. 8; and

FIG. 10 is a front elevation view of a milling cutter as a third embodiment of the present invention.

### DETAILED DESCRIPTION OF PREFERRED EMBODIMENTS

Hereinafter, there will be described a cutting process to which the present invention is applied, and a cutting tool and a tip which are suitable for carrying out the cutting process and to which the present invention is also applied.

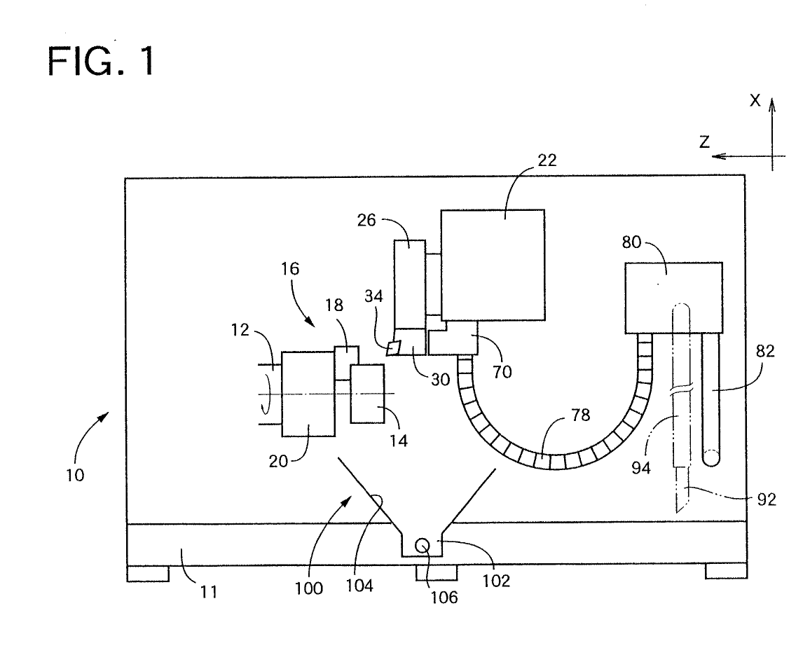

FIG. 1 shows a lathe 10 as a single-point-tool system that includes a plurality of single-point tools 30 each as a sort of cutting tool. In FIG. 1, reference numeral 11 designates a frame of the lathe 10 that includes a spindle stock (not shown). The spindle stock supports a main spindle 12 such that the spindle 12 is rotatable about a horizontal axis line. A chuck 16 for holding a workpiece 14 is attached to an end of the spindle 12, and the chuck 16 holding the work 14 is rotated with the spindle 12. In the present embodiment, the chuck 16 is a three-jaw chuck including a support member 20 and three jaws 18 (only one jaw 18 is shown in FIG. 1) which are supported by the support member 20 such that the three jaws 18 are equiangularly spaced from one another about the above-indicated axis line and are movable relative to one another axis-symmetrically about the axis line.

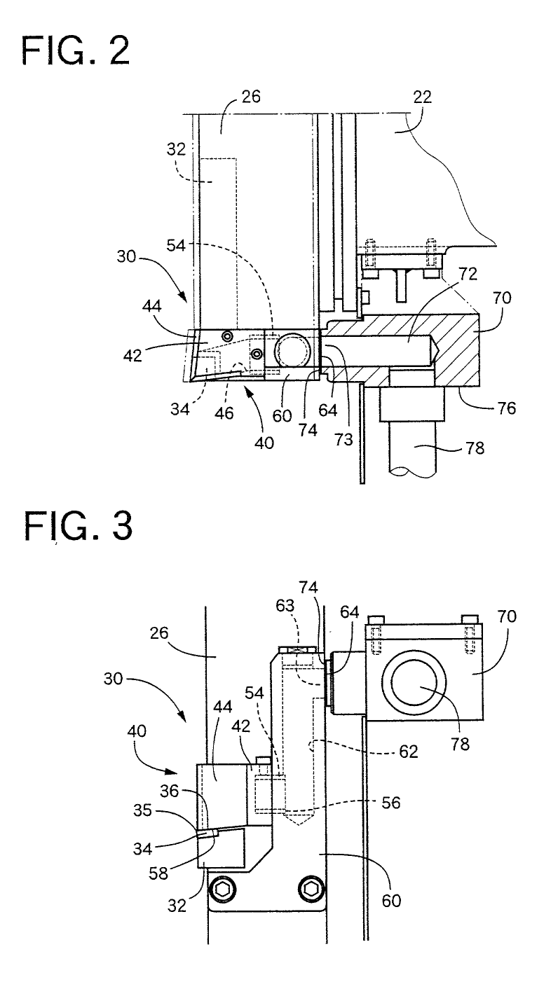

A turret 22 is opposed to the chuck 16 attached to the spindle 12. The turret 22 is moved by a turret moving device (not shown) in a horizontal, Z-axis direction parallel to the above-indicated axis line (i.e., centerline) of the spindle 12 and in a vertical, X-axis direction perpendicular to the Z-axis direction. The turret 22 includes a tool rest 26 which supports, on a circumferential surface thereof, a plurality of single-point tools 30 (only one single-point tool 30 is shown in FIG. 1). The tool rest 26 is clamped and unclamped by a clamping device (not shown) which is incorporated by the turret 22. In FIG. 2, the tool rest 26 being clamped is indicated at solid line, and an outer contour of the tool rest 26 being unclamped is indicated at two-dot chain line. The tool rest 26, in its unclamped state, is rotatable relative to the turret 22, so that the tool rest 26 is rotated by a tool-rest rotating device (not shown), at an incremental angle, and an appropriate one of the single-point tools 30 is positioned at an operative position where the one single-point tool 30 is used to cut the work 14 which is held by the chuck 16 and is rotated by the spindle 12. Then, if the tool rest 26 is clamped by the clamping device, the single-point tools 30 including the one single-point tool 30 positioned at the operative position are made immovable relative to the turret 22.

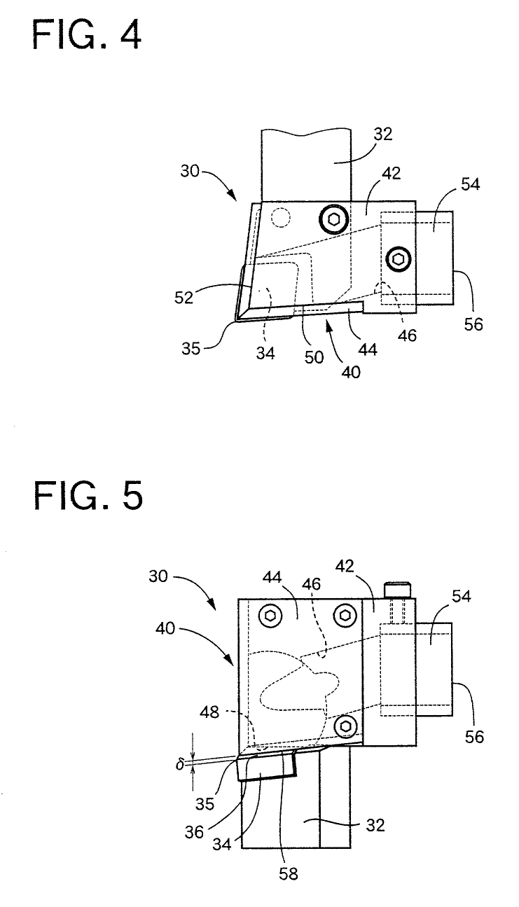

As most clearly shown in FIGS. 4 and 5, each single-point tool 30 includes a bar-like shank 32 as a main body whose base portion is fixed to the tool rest 26; and a throw-away insert or tip 34 which is detachably attached to an end of the shank 32. The tip 34 has a first cutting edge 35 including a major edge portion and a minor edge portion which project from the outer circumferential surface, and an end surface, of the tool rest 26, respectively. The cutting edge 35 is defined by intersecting lines of a rake face 36, a major flank 37, and a minor flank 38. A more detailed description of the single-point tool 30 will be provided later.

The rake face 36 of the tip 34 is covered by a cover device 40. The cover device 40 includes a support member 42 and a cover member 44 fixed to the support member 42. The support member 42 is provided by a block having a through-hole 46 formed therethrough, and is fixed to the shank 32 such that a cover surface 48 of the support member 42 is somewhat spaced from the rake face 36 of the tip 34. One end of the through-hole 46 opens in a portion of the cover surface 48 that is opposed to the rake face 36, and two side surfaces 50, 52 of the support member 42 that are adjacent to the cover surface 48. The other end of the through-hole 46 is communicated with an inner space of a hollow, cylindrical connection pipe 54 whose one end portion is fitted in the support member 42. The other end portion of the connection pipe 54 projects in a direction from the support member 42 toward the turret 22, and has an end surface 56. The cover member 44 has a shape which can substantially cover the two side surfaces 50, 52 of the support member 42 in which the through-hole 46 opens, and a small space which is left between the rake face 36 and the cover surface 48 of the support member 42. A clearance, δ, is left between the rake face 36 and a cover surface 58 of the cover member 44, and is communicated with the through-hole 46.

As shown in FIGS. 2 and 3, a connecting member 60 is fixed to a portion of the outer circumferential surface of the tool rest 26 that is near to each single-point tool 30. The connecting member 60 has a through-hole 62 formed therethrough, and the above-indicated other end portion of the connection pipe 54 is fitted in the through-hole 62, so that the first through-hole 46 is communicated with the second through-hole 62. The second through-hole 62 has an opening 63 which opens in a side surface 64 of the connecting member 60 that is located on the side of the turret 22.

In the state in which one of the single-point tools 30 is positioned at the operative position, if the turret 22 is moved along a cutter path by the turret moving device and the work 14 is rotated, an outer circumferential surface of the work 14 is cut and chips are produced.

The present lathe 10 carries out a semi-dry cutting operation in which the work 14 is cut while a cutting lubricant or liquid is supplied in the form of a superfine mist. Since the space left between the rake face 36 of the tip 34 and the cover device 40 is communicated with a suction device (not shown) via a main suction passage including the first and second through-holes 46, 62, an air flow is generated in that space, so that the chips are sucked with the air by the suction device. The suction device may be a vacuum pump and an electric motor for driving or operating the vacuum pump. Hereinafter, the main suction passage which connects the single-point tool 30 being positioned at the operative position, to the suction device, will be described.

As shown in FIGS. 2 and 3, a coupling member 70 is fixed to a lower end portion of the turret 22. The coupling member 70 has a passage 72 formed therein. The passage 72 has one opening 73 in a side surface 74 of the coupling member 70 that is located on the side of the single-point tool 30, and the other opening of the passage 72 opens in a lower surface 76 of the coupling member 70. In the state in which one single-point tool 30 is positioned at the operative position, the side surface 64 of the connecting member 60 and the side surface 74 of the coupling member 70 are adjacent to each other such that the respective openings 63, 73 in the respective side surfaces 64, 74 are aligned with each other, so that the second through-hole 62 and the passage 72 are connected to each other. In addition, one end of a flexible metallic hose 78 is connected to the opening of the passage 72 in the lower surface 76 of the coupling member 70. The hose 78 is formed of stainless steel, and is flexible to follow the movement of the turret 22. As shown in FIG. 1, the other end of the hose 78 is connected to a pipe 82 via a coupling member 80. The pipe 82 is connected to the above-described suction device via a coupling member, other pipes, etc. The connecting member 60, the coupling members 70, 80, the hose 78, the pipe 82, etc. cooperate with one another to provide the main suction passage. The chips which have been conveyed by the air flow through the main suction passage are collected by a chip collecting device (not shown).

A suction nozzle 92 is connected to the coupling member 80 via a flexible hose 94. When being not in use, the hose 94 is kept in a taken-up state. The nozzle 92 is used for cleaning the lathe 10 itself and its vicinity.

A chip receptacle 100 is provided at a position right below a working position where the work 14 is cut. The receptacle 100 has a conical shape whose diameter decreases toward a bottom portion 102 thereof. The receptacle 100 collects the chips which have not been sucked into the cover device 40 covering the single-point tool 30. The chips which fall from the cover device 40 are received by an inclined surface 104 of the conical portion of the receptacle 100, and are moved downward along the inclined surface 104 because of a gravitational force exerted thereto. The bottom portion 102 has an opening 106 to which a pipe (not shown) is connected. This pipe provides an auxiliary suction passage which is connected to the above-described main suction passage and is thereby connected to the suction device, so that the chips received by the receptacle 100 are sucked with the air by the suction device. Since the amount of the chips collected by the receptacle 100 is only several percents of the total amount of the chips produced by cutting the work 14, it is not required that the auxiliary suction passage be always communicated with the main suction passage. Rather, it is preferred that an open/close valve be provided in an intermediate portion of the auxiliary suction passage. The open/close valve selectively places the auxiliary suction passage in a first state in which the auxiliary passage is communicated with the main passage and a second state in which the auxiliary passage is not communicated with the main passage.

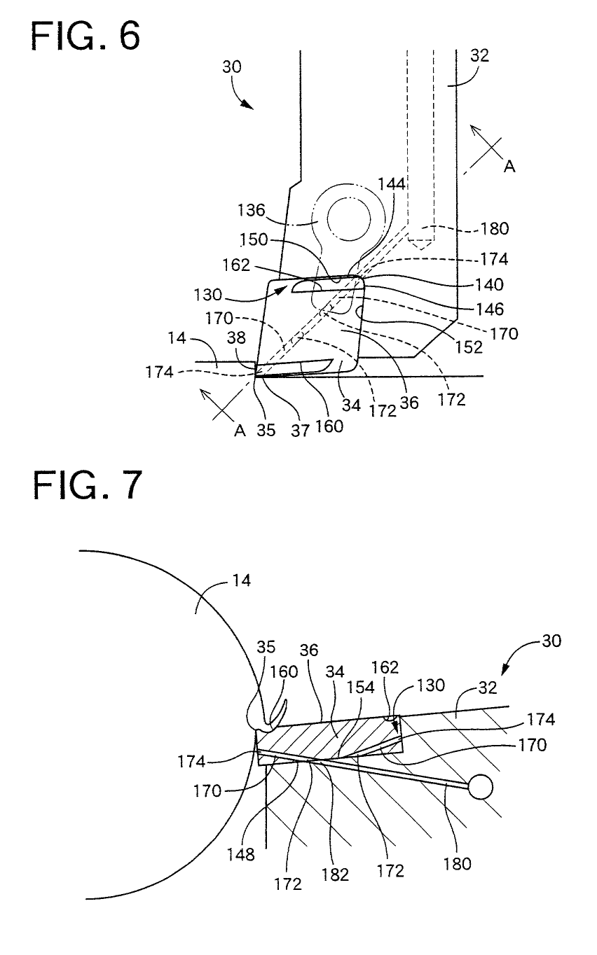

FIGS. 6 and 7 show one of the single-point tools 30 which are employed in the present lathe 10. It is noted that the cover device 40 is not shown in FIG. 6 or 7. The tip 34 has a parallelogrammatic shape in its plan view. The tip 34 is clamped to the shank 32 by a clamping device 136 (indicated at two-dot chain line in FIG. 6), such that the tip 34 is accommodated in a tip-hold recess 130 formed in an end portion of the shank 32. Since the clamping device 136 is well known in the art, it is not described or illustrated in detail. Alternatively, the tip 34 may be detachably attached to the shank 32 by fastening a screw member to the shank 32.

In the present embodiment, the tip 34 has, in addition to the first cutting edge 35, a second cutting edge 140 such that the two cutting edges 35, 140 are distant from each other along the longer diagonal line of the parallelogrammatic shape of the tip 34. Like the first cutting edge 35, the second cutting edge 140 has a major edge portion and a minor edge portion which are defined by respective intersection lines of the rake face 36, a major flank 144, and a minor flank 146. The single-point tool 30 is fixed to the shank 32, such that two side surfaces respectively including the major and minor flanks 144, 146 and a contact surface 148 are held in close contact with two side surfaces 150, 152 and a bottom surface 154 of the tip-hold recess 130 of the shank 32, respectively. The side and bottom surfaces 150, 152, 154 of the shank 32 provide tip-hold surfaces of the shank 32. When the first cutting edge 35 is worn out, first the clamping device 136 is unclamped to release the tip 34 from the shank 32, and then the tip 34 is rotated and is clamped again to the shank 32 such that two side surfaces respectively including the major and minor flanks 37, 38 and the contact surface 148 are held in close contact with the side and bottom surfaces 150, 152, 154 of the tip-hold recess 130. Thus, the second cutting edge 140 can be used in the cutting operation. The rake face 36 has two chip-breakers 160, 162 for the two cutting edges 35, 140, respectively.

The tip 34 has two mist holes 170 each of which provides a tip-side mist hole and has a circular cross section. One end 174 of each of the two mist holes 170 opens at a position in the vicinity of a corresponding cutting edge 35, or 140 and on a boundary between a corresponding pair of major and minor flanks 37 and 38, or 144 and 146, and the other end 172 of the each mist hole 170 opens at a position, in the contact surface 148, that is somewhat deviated from the center of the surface 148 toward the corresponding cutting edge 35, 140. Thus, each of the two mist holes 170 is obliquely formed through the tip 34 from a position in the vicinity of the center of the contact surface 148, toward the corresponding one of the two cutting edges 35, 140, and has the two openings 172, 174. In addition, the shank 32 has a mist hole 180, as a shank-side mist hole, which is formed therethrough and has a circular cross section. The mist hole 180 has an opening 182 in the bottom surface 154 of the tip-hold recess 130. This opening 182 is formed at a position where, in the state in which the tip 34 is attached to the tip-hold recess 130, the opening 182 is aligned with the opening 172 of one of the two mist holes 172 that corresponds to the currently used one of the two cutting edges 35, 140 (i.e., the cutting edge 35 in the embodiment shown in FIGS. 6 and 7). Thus, the opening 172 of the one mist hole 170 of the tip 34 that corresponds to the current cutting edge 35, 140 is communicated with the mist hole 180 of the shank 32, and the opening 172 of the other mist hole 170 is closed by the contact surface 148 of the tip 34. One end portion of the mist hole 180 of the shank 32 that has the opening 182 has the same diameter as that of the mist holes 170 of the tip 34, and the other end portion of the mist hole 180 has a larger diameter than that of the one end portion thereof, and extends toward the tool rest 26. The mist holes 170, 180 may be formed by electric discharge cutting or electro-chemical cutting. However, the one end portion of the mist hole 180 that has the opening 182 may have a diameter larger than that of the mist holes 170 of the tip 34.

The mist hole 180 of the shank 32 is connected to a mist supplying device (not shown) via a mist supply passage formed in the tool rest 26 and the turret 22. The mist supplying device supplies a superfine mist as a mixture of air and superfine particles of cutting liquid or lubricant that have an average diameter of from 1 to 2.5 μm. This mist supplying device is commercially available and, for example, a superfine-oil-mist spray device, “Ecomist”, available from Ebara Seisakusho, Japan, may be employed. A shank-side opening of the mist supply passage is so formed that only the mist holes 170, 180 of the one single-point tool 30 positioned at the operative position are communicated with the mist supplying passage formed in the turret 22. In the present embodiment, the shank-side opening 172 of each of the two mist holes 170 of the tip 34 functions as an inlet for the superfine mist supplied from the mist supplying device, and the cutting edge-side opening 174 of the each mist hole 170 functions as an outlet for the same.

When the work 14 is cut with the single-point tools 30 of the lathe 10 constructed as described above, first, one of the single-point tools 30 is positioned at the operative position, and then the turret 22 is moved along the cutter path by the turret moving device, while the work 14 is rotated. Simultaneously, the mist supplying device supplies the superfine mist of cutting liquid, from the opening 174 as the outlet of the tip 34, to a cutting point between the work 14 and the cutting edge 35, via the mist supply passage, the mist hole 180, and the mist hole 170. The chips produced by the cutting operation are sucked with air from the space between the rake face 36 of the tip 34 and the cover device 40, and are collected by the chip collecting device via the main suction passage. The chips which fall from the cover device 40 are received by the chip receptacle 100 and, when the open/close valve is opened, the received chips are sucked and collected by the chip collecting device via the auxiliary suction passage.

In the present embodiment, the superfine mist supplied from the outlet of the mist hole 170 of the tip 34 located near the cutting edge 35 is effectively supplied to the cutting point where the work 14 is cut with the single-point tool 30. Therefore, an excellent semi-dry cutting can be performed. In addition, the amount of consumption of cutting liquid or oil can be reduced. Moreover, the flow of air generated in the space between the rake face 26 of the tip 34 and the cover device 40 accelerates the movement of the superfine mist from the outlet of the mist hole 170 to the cutting point. This also contributes to improving the semi-dry cutting process. Furthermore, since the chips at a high temperature are removed by suction, the chips are effectively prevented from being scattered in the lathe 10 and being adhered to the single-point tools 30 and the work 14. This contributes to increasing the life expectancy and operation efficiency of the lathe 10. In addition, the reduction of amount of consumption of cutting oil and the prevention of scattering of chips improve the environment of the lathe 10 where one or more operators work. Since the chips collected by the chip collecting device have substantially no cutting oil adhered thereto, the chips can be easily treated.

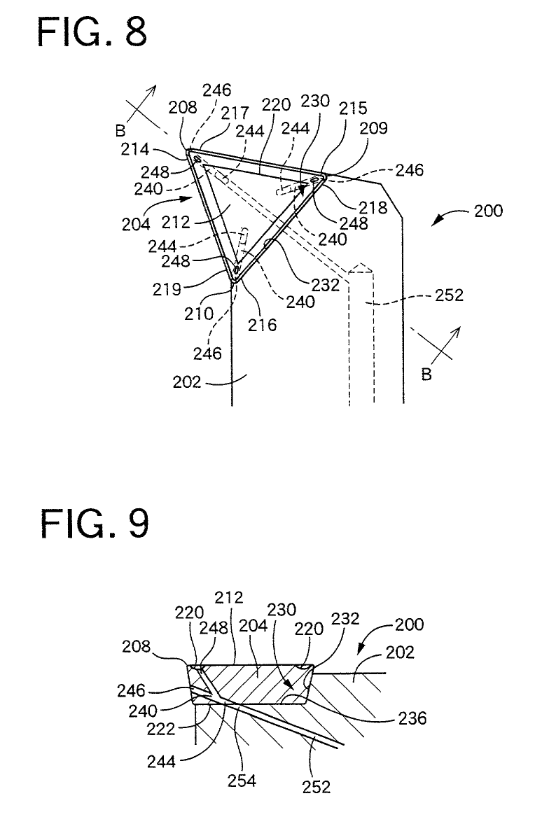

FIGS. 8 and 9 show another single-point tool 200 as a second embodiment of the present invention. Like the single-point tools 30, the single-point tool 200 includes a bar-like shank 202 as a main body, and a tip 204 which is detachably attached to an end of the shank 202. In the present embodiment, the tip 204 has a generally triangular shape in a plan view, and has three cutting edges 208, 209, 210 defined by three apexes of the triangle. When the current one of the three cutting edges 208, 209, 210 is worn out, the current edge is replaced with another edge. Each of the three cutting edges 208, 209, 210 has a major edge portion and a minor edge portion defined by respective intersections of a rake face 212, a corresponding one of three major flanks 214, 215, 216, and a corresponding one of minor flanks 217, 218, 219. The rake face 212 has three chip breakers 220 for breaking the chips produced by cutting a work (not shown). The three chip breakers 220 are connected to one another to have a triangular shape as a whole. In the single-point tool 200 shown in FIG. 8, the tip 204 is detachably attached, by a clamping device or a screw member (not shown) like in the first embodiment shown in FIGS. 1 to 7, to the shank 202 such that a side surface of the tip 204 that includes the minor flank 218 and the major flank 216, and a contact surface 222 of the same 204 are held in close contact with a side surface 232 and a bottom surface 236 of a tip-hold recess 230 which is formed in an end portion of the shank 202. Thus, the side surface 232 and the bottom surface 236 of the tip-hold recess 230 provide a tip-hold surface.

The tip 204 has three mist holes 240, each as a tip-side mist hole, which are formed through the tip 204. Each of respective one end portions of the three mist holes 240 that are located in the vicinity of the cutting edges 208, 209, 210 is bifurcated into two portions one 246 of which opens at a position on a boundary between a corresponding one of the major flanks 214, 215, 216 and a corresponding one of the minor flanks 217, 218, 219, and the other 248 of which opens at a position in a corresponding one of the chip breakers 220 in the rake face 212. Each of the respective other end portions 244 of the three mist holes 240 opens at a position somewhat deviated from the center of the contact surface 222 toward a corresponding one of the three cutting edges 208, 209, 210. Thus, each of the mist holes 240 is formed through the tip 204, obliquely, from a corresponding one of the three near-center positions toward a corresponding one of the cutting edges 208, 209, 210, and has the openings 244, 246, 248. Each of the openings 248 formed in the chip breakers 220 has an elongate shape for preventing the chips from entering itself.

Meanwhile, the shank 202 has, like the shank 32, a mist hole 252, as a main-portion-side mist hole, which is formed through the shank 202 and has a circular cross section. One end 254 of the mist hole 252 opens in the bottom surface 236 of the tip-hold recess 230. In the state in which the tip 204 is attached to the shank 202 such that the tip 204 is held in close contact with the recess 230, the opening 254 of the mist hole 252 is aligned with the opening 244 of the mist hole 240 associated with the current one of the cutting edges 208, 209, 210 (the edge 208 in the example shown in FIG. 8). Therefore, the opening 244 of one of the mist holes 240 (that is associated with the edge 208) is communicated with the opening 254 of the mist hole 252 of the shank 202, and the respective openings 244 of the other mist holes 240 (that are associated with the edges 209, 210) are closed by the bottom surface 236. Like the mist hole 180, one end portion of the mist hole 252 that has the opening 254 has the same diameter as that of the mist holes 240, the other end portion of the mist hole 252 has a larger diameter than that of the one end portion thereof, and the mist hole 252 extends toward a rear end of the shank 202. The mist holes 240, 252 may be formed by, e.g., electric discharge cutting or electrochemical cutting. However, the one end portion of the mist hole 252 that has the opening 254 may have a diameter larger than that of the mist holes 240 of the tip 204.

In the present embodiment, the opening 244 of each of the three tip-side mist holes 240 of the tip 204 functions as an inlet for a superfine mist of a cutting liquid supplied from a mist supplying device (not shown), and the openings 246, 248 of the each mist hole 240 functions as outlets for the same. Therefore, when the single-point tool 200 is used to cut the work, the superfine mist of cutting liquid supplied from the mist supplying device advantageously reaches the cutting point where the tip 204 cuts the work, via the openings 246, 248 as the outlets of the tip-side mist hole 240 and the shank-side mist hole 252.

In the second embodiment shown in FIGS. 8 and 9, the single-point tool 200 may be modified such that each of the mist holes 240 of the tip 204 opens in only the corresponding flank 214-219, like in the first embodiment, or in only the corresponding chip breaker 220.

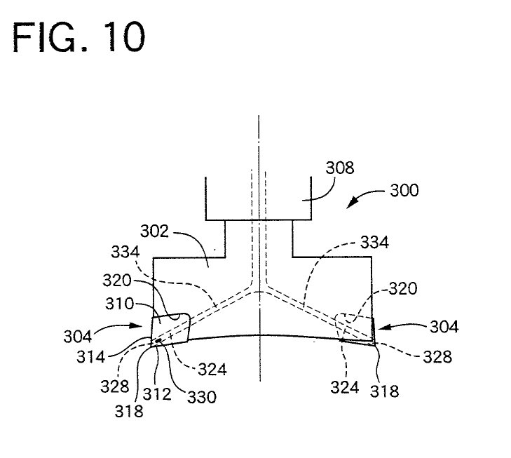

The present invention may be applicable to a cutting tool of a different sort from the above-described single-point tools 30, 200. FIG. 10 schematically shows, as an example of the different sort of cutting tool, a milling cutter 300 which is employed as a cutting tool in a milling machine. The milling cutter 300 includes a main portion 302 having a circular cross section, and three or more tips 304 which are detachably attached to an outer circumferential surface of the main portion 302 such that the tips 304 are equiangularly spaced from each other about a centerline of the main portion 302 in a circumferential direction of the same 302. FIG. 10 shows only two tips 304 which are diametrically distant from each other. A rear end portion of the main portion 302 is held by a main spindle 308 as a rotatable shaft member, such that the main portion 302 is coaxial with the spindle 308. The cutter 300 and the spindle 308 are rotated together with each other by a rotating or driving device (not shown).

Like in the first embodiment shown in FIGS. 1 to 7, each of the tips 304 has a generally parallelogrammatic shape in a plan view, and has a cutting edge 318 including a major edge portion and a minor edge portion defined by respective intersection lines of a rake face 310, a major flank 312, and a minor flank 314. Like in each of the first and second embodiments, each of the tips 304 is detachably attached to the main portion 302 such that two side surfaces of the each tip 304 that are distant diagonally from the major and minor flanks 312, 314, and a contact surface of the same 304 are held in close contact with two side surfaces and a bottom surface of a corresponding one of three or more tip-hold recesses 320 of the main portion 302. Each of the tips 304 may be replaced with one which has two cutting edges 318 in two portions thereof that are distant from each other along the longer one of two diagonal lines of the parallelogrammic shape. Each of the tips 304 has a mist hole 324, as a tip-side mist hole, which is formed therethrough. One end portion of each mist hole 324 is bifurcated into two portions one 328 of which opens at a position on a boundary between the major and minor flanks 312, 314 and the other 330 of which opens, in the rake face 314, at a position near the cutting edge 318. The other end portion of the each mist hole 324 opens in the contact surface of the each tip 304. Since each mist hole 324 has the same structure as that of each mist hole 240 shown in the second embodiment shown in FIGS. 8 and 9, no detailed description or illustration thereof is provided. In short, the opening of each mist hole 324 that opens in the contact surface of each tip 304 functions as an inlet for a superfine mist of a cutting liquid, and the openings 328, 330 of the each mist hole that open in the flank and rake face function as outlets for the same. The rake face 314 of each tip 304 may be provided with one or more chip breakers.

The main portion 302 has a plurality of mist holes 334, each as a main-portion-side mist hole, which are formed through the main portion 302. Each of respective one end portions of the mist holes 334 opens, in a bottom surface of a corresponding one of the tip-hold recesses 320, at a position which is aligned with the contact-surface opening of a corresponding one of the respective mist holes 324 of the tips 304. The respective other end portions of the mist holes 334 are connected to one another in a central portion of the main portion 302, and define a mist supply passage connected to a mist supplying device (not shown). Therefore, when a cutting process is started and a superfine mist of a cutting liquid is supplied from the mist supplying device, the superfine mist is advantageously supplied to the cutting point from the two openings 328, 330 of the current tip 304.

The number of tip-side mist hole or holes 324 of each tip 304 may be changed depending upon the number of cutting edge or edges 318. The number of hole or holes 324 may be one as shown in FIG. 10, or may be plural as shown in the first embodiment shown in FIGS. 1 to 7 or the second embodiment shown in FIGS. 8 and 9. Likewise, in each of the first and second embodiments, the number of tip-side mist hole or holes of each tip may be changed depending upon the number of cutting edge or edges thereof.

It is to be understood that the present invention may be embodied with various changes, modifications, and improvements, such as those described in SUMMARY OF THE INVENTION, which may occur to a person skilled in the art, without departing from the spirit and scope of the invention defined in the appended claims.

What is claimed is:

1. A cutting tool, comprising:
a main portion having a tip-hold surface;
a tip which has a cutting edge and which is detachably attached to the main portion such that the tip is held in close contact with the tip-hold surface of the main portion;
the tip having a tip-side mist hole which is formed through the tip and which has an inlet in a surface of the tip that is held in close contact with the tip-hold surface of the main portion, and an outlet in a portion of the tip that is located in a vicinity of the cutting edge; and
the main portion having a main-portion-side mist hole which is formed through the main portion and which opens, in the tip-hold surface, at a position aligned with the inlet of the tip-side mist hole of the tip attached to the main portion.

2. A cutting tool according to claim 1, wherein the main portion comprises an elongate shank including an end portion having the tip-hold surface, and the tip is detachably attached to the tip-hold surface of the shank.

3. A cutting tool according to claim 2, wherein the tip has a rake face, a major flank, and a minor flank, and the outlet of the tip-side mist hole opens in at least one of the rake face, the major flank, and the minor flank.

4. A cutting tool according to claim 1, wherein the main portion has a substantially circular transverse cross section, and wherein the cutting tool comprises a plurality of said tips which are attached to an outer circumferential surface of the main portion such that the tips are spaced from each other in a circumferential direction of the main portion.

5. A cutting tool according to claim 4, wherein the tips are attached to the outer circumferential surface of the main portion such that the tips are equiangularly spaced from each other about a centerline of the main portion in the circumferential direction thereof.

6. A tip for cooperating with a main portion of a cutting tool to provide the cutting tool, the tip being detachably attached to the main portion such that the tip is held in close contact with a tip-hold surface of the main portion, the improvement comprising at least one mist hole which is formed through the tip and which has two opposite ends one of which opens in a surface of the tip that is held in close contact with the tip-hold surface of the main portion, and the other of which opens in a portion of the tip that is located in a vicinity of a cutting edge of the tip.

7. A process of cutting a workpiece, comprising the step of:
cutting, with the cutting tool according to claim 1, the workpiece while supplying, to a cutting point between the tip and the workpiece, a superfine mist of a cutting liquid from the outlet of the tip-side mist hole via the main-portion-side mist hole and the tip-side mist hole.

8. A process according to claim 7, wherein the cutting tool comprises a single-point tool including the tip and a shank to which the tip is attached, and wherein the process further comprising the step of sucking, by vacuum, chips produced by cutting the workpiece, together with an air around the cutting edge of the tip, and thereby removing the chips from the single-point tool.
